(19) United States
(12) Patent Application Publication
(10) Pub. No.: US 2022/0283922 A1
(43) Pub. Date: Sep. 8, 2022

(54) SYSTEMS AND METHODS FOR ANALYZING AND SEGMENTING AUTOMATION SEQUENCES

(71) Applicant: Nice Ltd., Ra'anana (IL)

(72) Inventors: Yuval SHACHAF, Even Yehuda (IL); Yaron Moshe BIALY, Madrid (ES); Eran ROSEBERG, Hogla (IL); Hila KNELLER, Zufim (IL)

(73) Assignee: Nice Ltd., Ra'anana (IL)

(21) Appl. No.: 17/189,847

(22) Filed: Mar. 2, 2021

(51) Int. Cl. G06F 11/34; G06N 3/08

(52) U.S. Cl. CPC G06F 11/3438; G06N 3/08; G06F 11/3476; G06F 11/3452

(57) ABSTRACT

A system and method for segmenting or dividing a series of computer-based actions, for example into sentences, may provide a sequence of subsets of the series of actions to a neural network using a sliding window, and divide or segment the series actions into segments at points where the loss of the neural network is above a threshold. The dividing may include, for each of a sequence of computer-based actions within a sliding window determining if the sequence when provided to the neural network corresponds to a loss above or equal to a threshold, and if so, determining that an action in the sequence of actions within the sliding window should not be part of a segment or sentence being created.

### FIELD OF THE INVENTION

The present invention relates generally to analysis of computer usage and development of automation, in particular to dividing sequences of user actions into segments.

### BACKGROUND OF THE INVENTION

Organizations such as call centers, or other businesses, may want to identify sequences of often repeated user inputs or actions, which may be called business processes, in order to create computer automation sequences (where a computer might automatically perform the actions) or to suggest to a user the best next action for the user to take (e.g. enter into a computer program). Such user actions may be human (e.g. user) inputs to a computer, such as clicking on a data entry field, typing in a name, clicking “continue”, etc. and may be organized into business processes such as entering a new customer into a data entry system.

A business process may be a sequence of computer inputs, e.g. actions. It is desired to identify business processes within an organization or enterprise that are significant candidates for automation. Good candidates may be feasible for automation and have a high potential return on investment (ROI) by saving significant manual efforts and workloads when being handled by computerized robots instead of by human agents. Computerized robots nay be processes executed by computers which enter the actions into computer executed applications in place of humans entering the actions.

Discovery and analysis of business processes is typically performed manually, and such discovery is not optimal due to for example (a) the identified flows may be difficult to justify (in terms of profitability and automation ROI); (b) other, more significant, flows can be easily missed; and (c) the discovery process is biased, time consuming and very expensive. Building successful automation processes requires a deep understanding by a human of what should be automated and knowing what the sequence of steps should be to ensure the automation runs successfully. The skill level required of the business analyst of data engineer creating the automation is very high, and the process itself can be very time consuming. Skilled automation creators will be able to resolve these issues manually, but this takes time and such a process is prone to mistakes.

### SUMMARY

A system and method for segmenting or dividing a series of computer-based actions, for example into sentences, may provide a sequence of subsets of the series of actions to a neural network (NN) using a sliding window, and divide or segment the series actions into segments at points where the loss of the NN is above a threshold. The dividing may include, for each of a sequence of computer-based actions within a sliding window determining if the sequence when provided to the NN corresponds to a loss above or equal to a threshold, and if so, determining that an action in the sequence of actions within the sliding window should not be part of a segment or sentence being created.

Embodiments may input or collect a log of all desktop actions performed by a user or employee, and may be performed across many different employees. In terms of numbers, there may be approximately 6,000 such actions on average per employee per eight-hour workday. Embodiments may identify how to cut, segment or split the stream of actions into related sequences, sentences or segments, which then may be the basis for the discovery pipeline.

Embodiments may automatically identify the most significant business flows for automation and improve automation technology by automatically breaking, segmenting or splitting a stream of actions into sentences, thereby greatly improving previously achieved discovery results. Novel NN and machine-learning technologies may be used to greatly improve discovering the most significant business flows for automation. Embodiments may more effectively, quickly, and with less computer processing identify the most significant automation opportunities from sequences of actions.

### BRIEF DESCRIPTION OF THE DRAWINGS

Non-limiting examples of embodiments of the disclosure are described below with reference to figures attached hereto. Dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features and advantages thereof, can be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a block diagram of a system for providing a next action according to an embodiment of the present invention.

FIG. 2 describes a data and processing flow including a sliding window according to embodiments of the present invention.

FIG. 3 depicts a set of losses for a series of windows of actions input to a NN, depicting which windows have losses above and below a threshold, according to an embodiment of the present invention.

FIG. 4 is a flowchart of a method according to embodiments of the present invention.

FIG. 5 is a high-level block diagram of an exemplary computing device which may be used with embodiments of the present invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, and components, modules, units and/or circuits have not been described in detail so as not to obscure the invention.

Prior art attempts process mining include technology such as the Celonis system, the TimelinePI system, the ProcessGold system, and the Minit system, which may identify potential automations based on system event logs, in contrast to embodiments of the present invention, which may use desktop rather than system events. In system event log methods, data is gathered from log events of a specific enterprise application, which is lengthy process, and requires the cooperation of the software developer of the target software application (some of which may not have such logs that can be used). Embodiments of the present invention may instead collect data on its own—not from the target application—from user desktop actions, which are different in format and source from system event logs.

By collecting low-level user actions, embodiments of the present invention may collect all user actions and inputs, regardless of application, and regardless of whether or not the application is an Internet browser-based application or not and may not require integrations or interfaces to multiple different specific applications.

In some embodiments for each action the collected data includes, for example the action data (e.g., mouse or keyboard), timestamp, application context and, where possible, field context. In process mining and system event log methods analysis may be on level of step-in-business-process but does not take into the account the actual actions employee has to take in order to complete a specific step in a process. The data in such prior methods may be labeled by definition (e.g. label exists in the data gathered from the event logs) making it simpler to analyze. An advantage of process mining tools may be that they present the organization with a complete end-to-end flow, identifying potential bottlenecks. Disadvantages may include the lengthy process to gather data, the lack of complete data and the disconnection between steps in a flow to what can be automated by robotic process automation (RPA) for each step of the flow, and that customers may need to know in advance which process to analyze, as opposed to embodiments of the present invention which may be unsupervised and may answer the general question of “what should we automate”.

Embodiments of the invention may work without high-level system-specific event logs and may instead use low-level user input data, without being associated to activities or process instances. Prior art systems may use high-level system specific event logs which may specifically identify the process or program instance, e.g., a number, and an activity ID (e.g. a unique identifier of each activity in a process) which may specify or identify the task that has been performed by a user or a computer system. In contrast, the low-level event data recorded and used in embodiments of the present invention may not be associated with a specific process rather only with a window which has a name and with a program or application operating the window (e.g. an internet browser). The title (e.g., the label displayed at the top) of the screen window, and the name of the program executing with which the user is interacting are data may be extracted or obtained and are different from, the specific identification of the process or program instance which in some cases may not be obtained. Event log data such as an activity ID may be data internal to a program and may not be provided to other programs; in contrast data such as window names may be more accessible and agnostic to the various programs and applications.

Technologies exist to obtain high-level system-specific event logs as input data, activity ID and, timestamp to identify user activity or input. An activity ID may specify the task that has been performed as part of the process. Such data is typically provided by the application itself, and may not be provided for all applications, and thus a process using this data works with incomplete data. Data such as an activity ID, user selection and input may be data internal to a program and may not be provided to other programs. Current processes analyzing user actions or input do not use accessible low-level desktop events as input data; such low-level data may not be associated with a specific process but rather may be associated only with a window and a program operating the window (e.g. an internet browser).

Prior art discovery tools may collect and analyze data based on images, and not on the more technically challenging data collection based on application and application-fields context, and collect and analyze much less data than the improved embodiments discussed herein. Improvements discussed herein may handle more data, in a sometimes completely unsupervised and unlabeled manner. Embodiments may more effectively, quickly, and with less computational demands identify the most significant automation opportunities.

Actions may be for example both the actual events of a user providing input to a computer and data descriptions of those events such as user desktop event representations: thus in some cases action and event may refer to the same thing. A sentence may be a sequence or a string of user actions that acts as an entire input to perform some business process. These sentences of user actions may act as a combination of several actions that express a particular business functionality. Using sentences, repetitive sequences may be identified, which may be those sequences that have corresponding user actions that are consecutive and/or within the same time-frame and are repeated within a stream of user actions. The sequences may be filtered to identify the best ones of the sequences, for example those that have the highest ROI. Once significant sentences are identified and named, those may be used to build automation processes, or templates that permit entry of dynamic text when form filling or otherwise executing a business process.

Events may be generated, by users or administrators (e.g., agents of an organization) of client systems or devices, e.g. user terminals, based on input and processing requests to the client devices, such as input and data while performing operations (e.g. user input to applications) on the client devices. An example representation of action is shown in Table 1; other representations of actions may be used. In Table 1, the action of a user left-clicking (using a mouse, e.g.) on a certain window is shown. The representations in Table 1 may be in the form of strings.

TABLE 1
“type”:“Click”
“name”:“LeftClick”
“activeWindow”: { “processName”:“iexplore”, “title”:
“RITM0080385 | ServiceNow - Internet Explorer”}
“actionComponent”: { “Name”:“All applicationsFavoritesYour history(tab)”,
“ControlType”:“tab item”, “Id”:“6”,“ClassName”:“”}

Embodiments may take input from low-level desktop events, as opposed to application-specific information, and thus may be agnostic to the different enterprise or other applications. Some embodiments may be agnostic to the domain (e.g. the platform and specific programs as well as customer type, segment market, etc.) and language used for user interfaces, or other data, and may work with any data, for any specific programs the user interfaces with. Using a data gathering process, low-level user action information items, each describing input or action by a user (e.g. of the computer desktop system), may be received or gathered. Each low-level user action information item may include for example an input type description and screen window information. This process may be used to develop a database of action sequences.

Low-level user action information may be collected in the form of handles or objects and their properties as provided by Windows API and other similar APIs (e.g. Win-32 or JVM or others). The event logs files describing these data collected desktop events collected may be exported using JSON (JavaScript Object Notation) files. Other low-level event or action data may be used. The data may include for example event or action time (e.g. start time, but end time may also be included); user details (e.g. name or ID of the person providing the input or taking the action in conjunction with the computer); action details, type or description (e.g. mouse-click, left-click, right click, keyboard input, cut, paste, application context, text-input, keyboard command, etc.); the details of the window in which the action takes place, such as the window size, window name, etc.; the name of the program executing the window; field context and text if any that was input or submitted (in text actions). Computer processes in this context may be displayed as windows, each window may have a title or name which may describe the user-facing application to which the user provides input. Each low-level user action may be described in a database by several fields of the action data such as action time, user details, action details, window name and size, program executing the window, and whether or not text was entered. Action data describing each action may be concatenated to a single string to name the action. Other or different information may be collected.

A generalized name or description may also be created and associated with the action, at various points in the processes described (e.g. for processing a general database of user actions, or for processing a set of actions downloaded from a specific agent computer). A name may have certain specific information from the specific action name, such as user ID, timestamp, and other tokens in the data (e.g., names, dates, etc.), removed or replaced with generalized information. Multiple specific instances of similar actions may share the same generalized name or description. Thus actions may be stored and identified by both identifying the specific unique (within the system) instance nor name of the action, and also a generalized name or description.

Generalization of each action may be done in order to represent actions not specific to one recorded instance. A generalization process may ensure that actions with the same business functionality, or which are functionally equivalent in terms of use, are considered as identical even though they may seem slightly different due to different details such as time or user ID.

An action description may summarize the action's information, but may have unnecessary information (e.g. may be noisy) due to various tokens such as names, addresses, IP numbers, etc. For example, in the two following action descriptions, stored e.g. as strings:

• “User InputText(Agent1) on Username in MyOrderingSystem-Login - iexplore”
• “User InputText(Agent2) on Username in MyOrderingSystem-Login - iexplore”

both represent the same functionality of inserting username (e.g. Agent1, Agent2) in the Username field, but the two descriptions are different as each contains a different name. In order to be able to express the identity of the two different actions, a generalization process may substitute or replace the certain tokens or data items (e.g., the “name” token) with more general or placeholder descriptions, or remove certain tokens. For example, the above two descriptions can be both be generalized as the following single description or text string, which applies to both: “User InputText(NAME) on Username in MyOrderingSystem-Login—iexplore”. While in one embodiment only names generalization (e.g. of a name or user ID field) is used, a similar generalization process may be performed for other fields as well. The generalization process may return for example, a database where each entry for a specific unique instance of an actions includes a field including a generalized name for that action that may be shared with other actions.

In one embodiment, input may be a log or database of desktop actions, e.g. user input or actions to a graphical user interface (GUI) for a variety of applications performed by one or more employees.

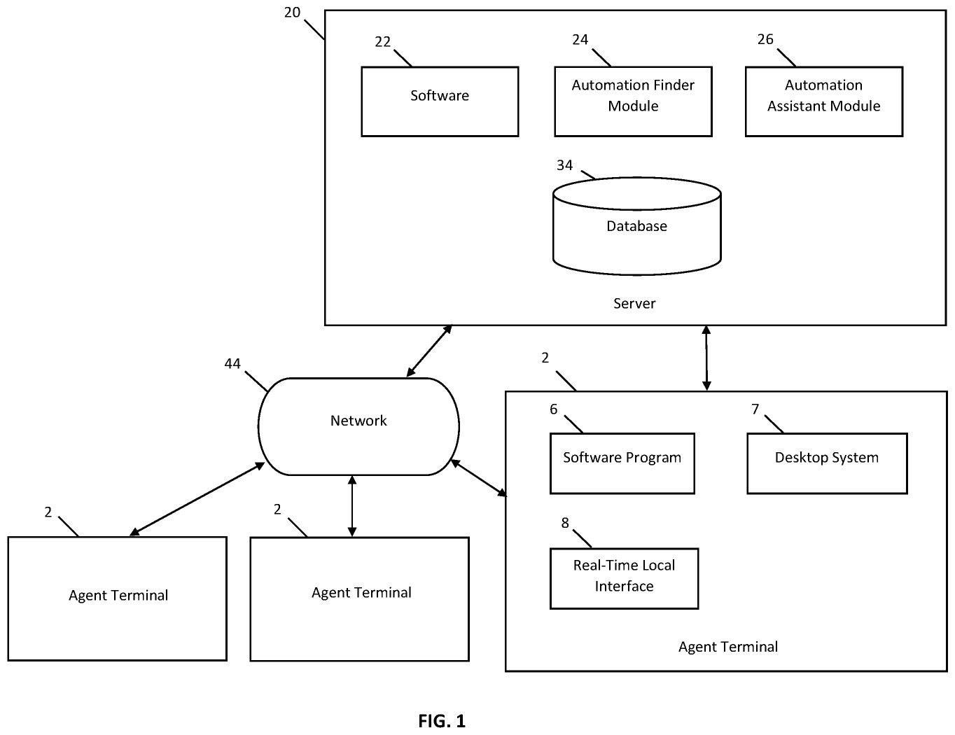

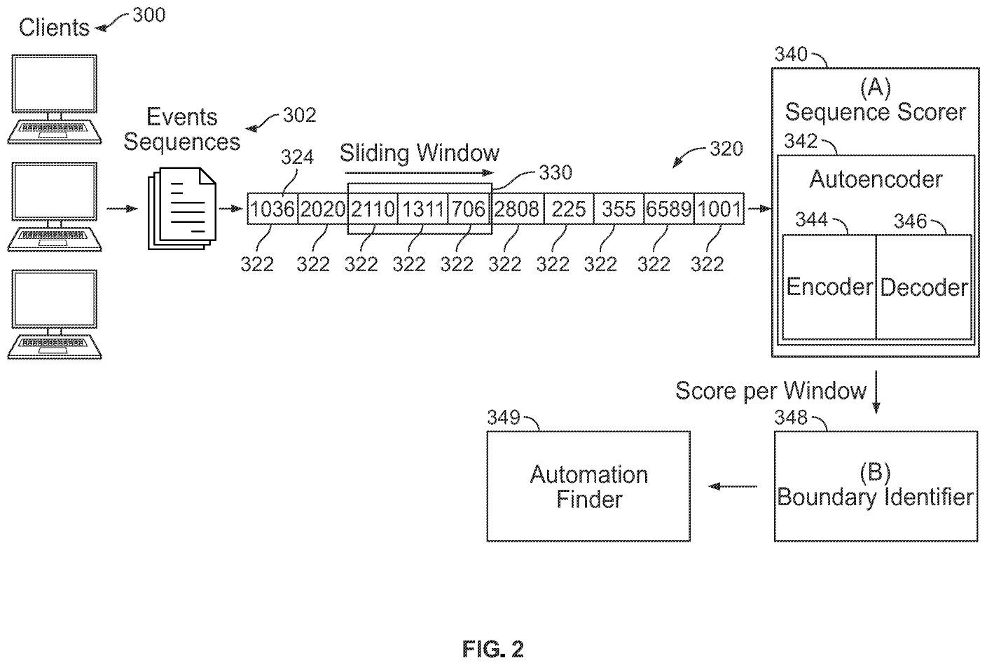

FIG. 1 is a block diagram of a system for providing a next action according to an embodiment of the present invention. While FIG. 1 shows such a system in the context of a contact center, embodiments of the invention may be used in other contexts. A number of human users such as call-center agents may use agent terminals 2 which may be for example personal computers or terminals, and which include one or more software programs 6 to operate and display a computer desktop system 7 (e.g. displayed as user interfaces such as a GUI). In some embodiments, software programs 6 may display windows, e.g. via desktop system 7, and accept user input (e.g. via desktop system 7) and may interface with server software 22, e.g. receiving input from and sending output to software programs 6. A real-time (RT) local interface 8 (e.g. a NICE Attended Robot provided by NICE, Ltd.) executing on terminals 2 may collect user action data, execute an automation sequence in place of user input or provide or display a recommended next action to a user, according to automations created.

RT local interface 8 may act as client data collection software such as an activity recorder or action recorder and may monitor input to programs 6. For example RT local interface 8 may receive, gather or collect a user's desktop activity or actions, e.g. low-level user action information or descriptions, and send or transmit them to a remote analytics server 20 (e.g. as JSON or other files), which may also function as e.g. a NICE RT™ Server. RT local interface 8 may access or receive information describing user input or actions via for example an API (application programming interface) interface with the operating system and/or specific applications (e.g. the Chrome browser) for the computer or terminal on which it executes.

Data such as Win-32 event logs of user's actions may be received or loaded from, e.g. RT local interface 8 and the various fields may be extracted and stored in a database. An action may include the following example data fields (other or different fields may be used):
Action time;
User details (e.g. user ID, user name, etc.);
Action details: e.g. mouse-click, text-input, keyboard command, etc.;
Window details: window-size, window-name, etc.; and
Text that was submitted if any.

An analytics server 20 may host for example machine learning components for an automation finder module 24. Modules may provide useful output of the automations created; for example an automation module 26 may be included. Software 22 executed by analytics server 20 and programs 6 may interact in a client-server manner. Remote analytics server 20 may collect or receive data such as user action information or descriptions and transmit or export them to for example a database 34. Automation module 26 may provide output based on automations, for example a next suggested action to a user, or a set of actions to operate a program on terminals 2.

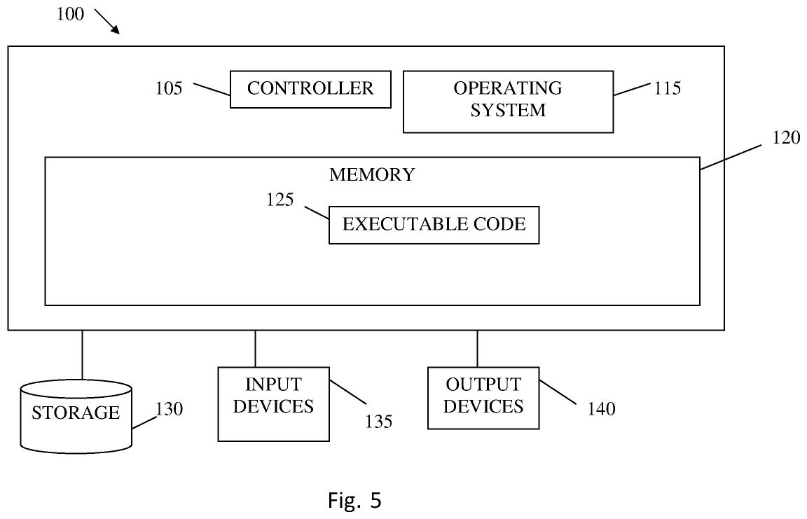

One or more networks 44 (e.g. the internet, intranets, etc.) may connect and allow for communication among the components of FIG. 1. Terminals 2 and server 20, may include some or all of the components such as a processor shown in FIG. 5.

An agent operating an agent terminal 2 typically performs business processes, and may have business processes recorded by, for example, by RT local interface 8 from other modules discussed herein, and sent to automation finder module 24.

Automation finder 24 may identify automation opportunities by discovering repetitive sequences of actions, for example using desktop analytics and machine-learning. Automation finder 24 may identify sets of sequences with automation potential, or perform other functions. Automation finder 24 may include an artificial intelligence (AI) server or capability which may pre-process collected low level actions or events; and form, segment or split (typically in an unsupervised manner) the stream of user actions into sentences each forming a segment, usually bounded by time, of actions that form a sequence of user actions. Such sentences describe an instance of a task. Automation finder 24 may perform sequence mining, sequential pattern mining, finding repetitive sequences in a given data that contains a set of sentences; and a find process function, grouping the previously found sequences into processes, each process potentially describing a business process or part of it.

While specific functionality is assigned to specific modules, in other embodiments other modules may perform functionality described herein.

FIG. 2 describes a data and processing flow including a sliding window according to embodiments of the present invention. Typically, operations in FIG. 2 are carried out by a computer system such as that shown in FIGS. 1 and 5, but other systems may be used. Referring to FIG. 2, embodiments may collect user desktop actions 302, e.g. from desktop clients 300 such as RT local interface 8, form the actions into events or actions sequences, then pre-process these actions in order to assign a label 324, such as the example system of the four-digit number used herein, to label actions 322 that may be repeated by different users (at different times, with different specific data) but which are in essence the same action occurring different times and different places.

Labels or names other than four digit numbers may be used. After receiving users' sequential actions, and representing these actions with unique integer name or integer ID, such as label 324, per action type or generalized actions, the actions may be sorted by user and secondarily by timestamp (e.g. when the action took place) such that the actions from all users may be concatenated to a long integer sequence 320, each individual user's action being consecutive within a section of action sequence 320. Each action 322 in sequence 320 may correspond to a unique action but may have a label 324 which is common to similar other actions with sequence 320. Thus each individual action label 324 may appear more than once in sequence 320. A sequence of action names or labels, each linked to or associated with one or more actual actions which correspond to the generalized name, and representing multiple different specific instances of user tasks or processes may be created.

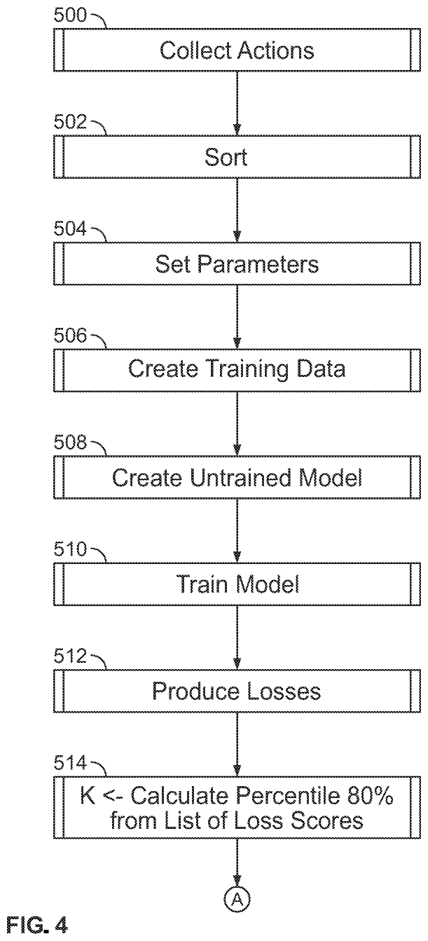

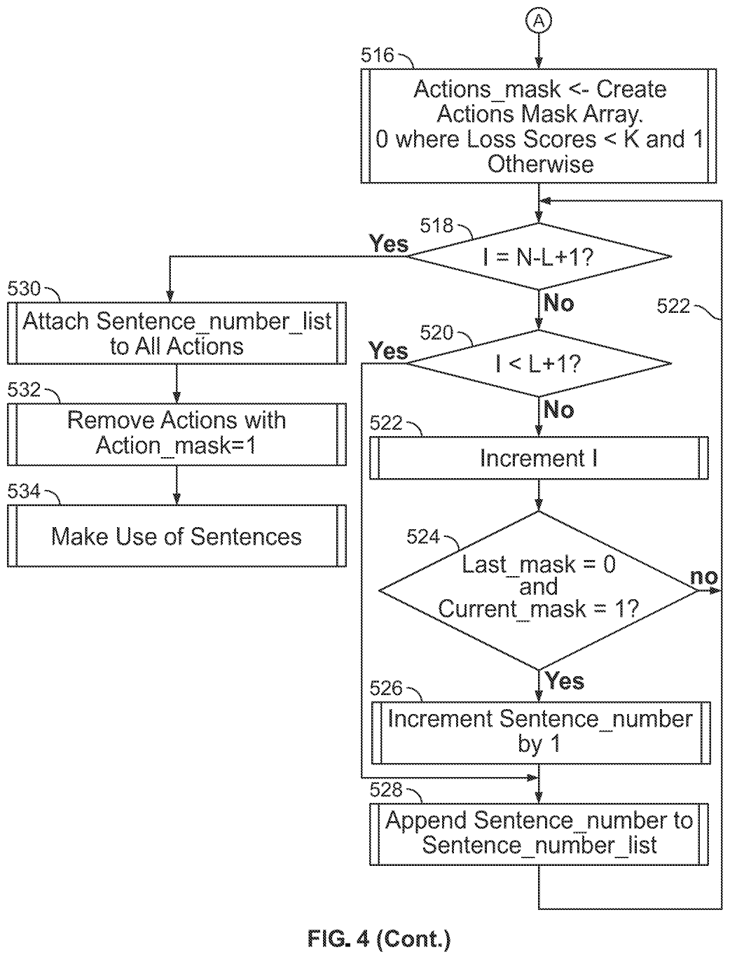

A sliding window 330 with a pre-defined size L, e.g. 10 (for clarity, less than 10 actions are shown in the window in FIG. 2), may be slid over the input data (the long sequence of N actions 320) from beginning (e.g. earlier) to end (e.g. later), typically incremented by one action at a time. Window 330 defines a subset of input from actions 320 to input or provide to a next process, and thus a series of overlapping inputs, being a series of actions the size of window 330 (e.g. 10 actions), are input to the next task. In some embodiments window 330 is used to provide input to a sequence scorer module 340, which may, for each input window 330 (e.g. including a series of actions) calculate a score or rating that represents the chance for this window to be a part of a task and not a random or seldom-seen actions sequence. This may be performed by applying a pre-trained neural-network based model which quantifies the window score, as described herein. Sequence scorer module 340 may include and use autoencoder module 342 (in turn including encoder 344 and decoder 346), and may output data such as scores or ratings to boundary identifier module 348, which may use the scores or ratings to segment or divide all the events into sentences based on those input windows having scores below a pre-defined threshold K, with certain sequences of actions not included as any sentences. Each sentence may be part or all of a user task such as filling in a form. For example, some or all action sequences in windows corresponding to loss above (e.g. greater than), or above or equal to, a threshold may not be included in any sentences and thus “cut out” of the original sequence. Automation finder 349 (which may be the same or similar to automation finder 24) may analyze input actions to find segments or sentences, for example according to the operations of FIGS. 2 and 4. In some embodiments, only events identified as sentences may be used in a sequence mining phase. The functionality of FIG. 2 may be included in for example server 20 of FIG. 1.

A NN may refer to an information processing paradigm that may include nodes, referred to as neurons, organized into layers, with links between the neurons. The links may transfer signals between neurons and may be associated with weights. A NN may be configured or trained for a specific task, e.g., pattern recognition or classification. Training a NN for the specific task may involve adjusting these weights based on examples. Each neuron of an intermediate or last layer may receive an input signal, e.g., a weighted sum of output signals from other neurons, and may process the input signal using a linear or nonlinear function (e.g., an activation function). The results of the input and intermediate layers may be transferred to other neurons and the results of the output layer may be provided as the output of the NN. Typically, the neurons and links within a NN are represented by mathematical constructs, such as activation functions and matrices of data elements and weights. A processor, e.g. CPUs or graphics processing units (GPUs), or a dedicated hardware device may perform the relevant calculations. During training, or during inference, a loss or loss functions may be produced, measuring the error or difference between the output and the expected or correct (“ground truth”) output. In an autoencoder, where the input and output are expected to be the same, the loss may measure deviation between the input and output.

Sequence scorer module 340 may provide a score or rating which quantifies how likely a certain event or action, typically represented by proxy by a window containing a subset of actions in the sequence which includes the certain event or action, is part of a task and not merely a random action. Sequence scorer module 340 may use autoencoder module 342, typically a neural-network based model. An autoencoder may be a model which learns to compress data and reconstruct it. Embodiments of the present invention may train a model which is part of autoencoder module 342 to compress the series of actions in a window and reconstruct it.

In some embodiments, a well-trained autoencoder may be able to reproduce the input data but fail for random sequences: this failure may be detected in the loss function generated at inference by the autoencoder. Tasks may be typically repeated as training input to a NN, and thus may be detected as having low loss, where rarely seen or random series of actions may cause the trained NN to produce high loss. The score that quantifies the success of the autoencoder may be based on the loss function (e.g. the lower the better), and thus low scores can be expected for within task sequences, where the NN loss will be low since the autoencoder has been well trained with such sequences, and high score for between-task actions which include sequences that are not well trained in the autoencoder, resulting in high NN loss.

Autoencoder module 342 may be or include an unsupervised NN that takes or has provided or input to it input data (e.g. a sequence of actions), compresses it to a smaller size representation (e.g. a vector, an ordered series of numbers, with lower dimension) and then reconstructs it. The goal is to build an output which is as close as possible to the input “image”, for example a series of actions defined by a window. The autoencoder may include encoder 342, which may encode the data to a lower dimension vector and decoder 344, which may reconstruct the data from the compressed representation. Encoder 342 and decoder 344 can be implemented using any suitable NN architecture, e.g. fully connected network, recurrent NN (RNN), convolutional NN, etc.

Before inference can take place to produce losses used to segment sentences, an NN such as autoencoder module 342, is trained using the same data set as will be used during inference. During training the sliding window (of the same size used during inference) is used to generate input training data, a set of lists or subsets of series of events, or sequences, each with L actions, L being the size of the sliding window. The window may move along the data input, typically from beginning to end, incremented each time by a number of actions (typically one action) to provide a sequence of subsets of the series of computer-based actions to a NN, each subset defined a sliding window. When discussed herein, the “window” may be the L-action length defining a subset of actions in the sequence of actions, and also may be used to refer to the subset of actions itself. The NN may be trained using the standard approach of Stochastic Gradient Descent, or other methods. The objective, or loss function, may be categorical cross entropy, which is a loss function that is used in multi-class classification (e.g. each integer ID in a sequence is a class) where each model output can only belong to one out of many possible categories, and the model must decide which one. Other loss functions may be used. The categorical cross entropy loss function may calculate the loss of an example by computing the following example sum:

$$CE = - {\sum }_{i}^{C} {t}_{i} log ( {s}_{i} ) \qquad Equation 1$$

Where CE is the categorical cross entropy loss; C is the number of classes (e.g. the number of unique action IDs or labels, for example the vocabulary size); t is the target or expected probability; and s is the output prediction probability. During training, as is known in the art, a process may try to find the network parameters that will minimize the loss function by using an iterative process of forward calculation of the loss and then backpropagating the loss gradients to the autoencoder parameters. The process continues before (e.g. so as not to overfit) or until convergences (e.g. the loss is not decreasing anymore).

After autoencoder module 342 is trained it may be used during inference to a calculate per window score. The same data used for training may be input to autoencoder module 342 by applying the sliding window (having the same dimension as in inference) in the same manner. The window may move along the data input, moved or incremented each time by a number of actions (typically one) to provide a sequence of subsets of the series of computer-based actions, possibly represented as windows—one subset per window movement—to a NN, each subset defined by the sliding window. For each window of input data, the trained NN or autoencoder module 342 may calculate the score by calculating the NN loss function between the network output and the target which is actually the input. The window may be assigned this score (the loss), the lower the better. Lower loss may indicate the model managed to learn a good representation of the input which means the sequence is not a noise or random but rather a good representation of some task.

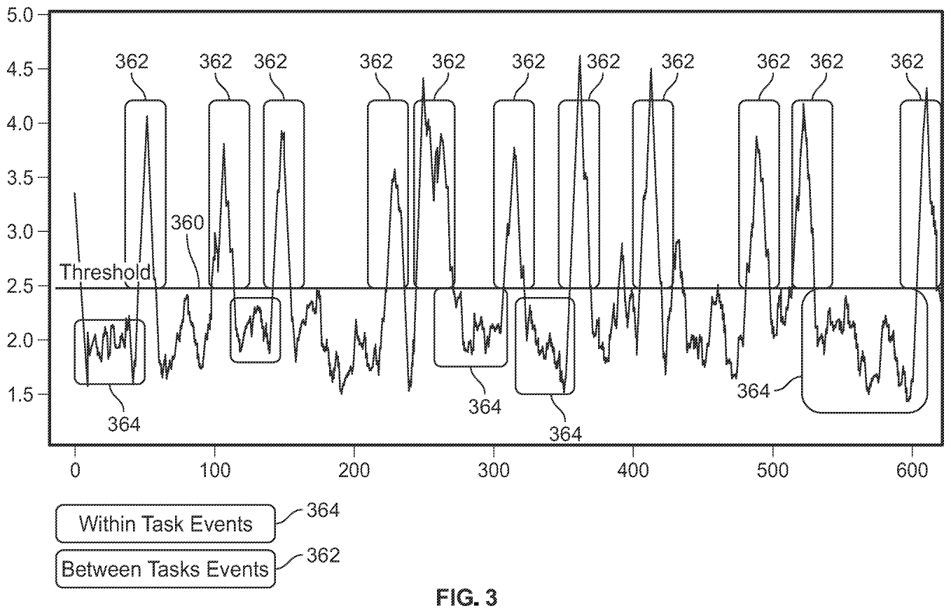

FIG. 3 depicts a set of losses for a series of windows of actions input to a NN, depicting which windows have losses above and below a threshold, according to an embodiment of the present invention. After a score per each window (e.g. each subset of actions) is calculated a process may use the scores to find or determine the within tasks events (typically indicated by low NN loss) and in-between task events (e.g. high loss). A threshold may be determined or calculated such that windows with a higher score are considered as between tasks and windows with lower loss score than the threshold are considered as within task. In the graph depicted in FIG. 3 the X axis indicates the event or action position in a series of computer-based actions and the Y axis is the score for the action. In some embodiments, the loss value or score for an individual event or action may be taken from the loss or score for the window of actions that ends in that action, or the position within the larger series of actions corresponding to the individual event or action. Other actions in a window may be marked as related to the loss, e.g. a beginning action or more than one action. Further, other specific ways of determining segmentation based on high loss may be used: e.g. an embodiment may stop and end a sentence in the middle of a high loss region or high loss window, such that half of high loss action would go to one sentence X and half to subsequent sentence X+1.

In FIG. 3, threshold 360 determines windows and actions which are in sentences and which are, not, or are boundary or in-between. Regions 362 depict actions within windows containing subsets of actions, or occurring at a certain position within a window (e.g. the last action), that have high loss, above or equal to threshold 360, and which are thus in-between sentences, or which indicate places to segment into segments. Regions 364 depict actions within windows containing subsets of actions, or occurring at a certain position within a window (e.g., the last action), that have low loss, below threshold 360, and which are thus in sentences. While “equal to or above threshold” and “below threshold” are used, in other embodiments these may be reversed, so that windows above a threshold are in-between and those having scores below or equal to a threshold are sentences. A threshold may be defined by a percentile, or in other embodiments a pre-set value. For example, a pre-set percentile of 80% may be used to determine, after loss values are calculated, a threshold at a loss level such that 80% of the loss values are below the threshold; other percentages may be used. In such an example windows, actions or positions with the lowest score, below this percentile are in sentences (e.g., “within task” position) and all the others as a “between task” positions. “Within task” events placed in sentences may be considered to be potential sequences, and these sequences may be fed to a sequence miner to search for patterns in the sequences.

In some embodiments, the loss of or associated with a window defining a subset of actions may indicate that a certain subset of actions within the subset should be appended to or included in a sentence and a certain subset should not. Each new subset within a window, as a sliding window moves across the input, reveals or includes a new action (typically one new action, as the window is typically incremented by one) and drops, forgets or omits the first action in the previous window (e.g. first in last out). Thus the window loss or score typically if affected by and refers to the newest (e.g. at very right hand side in some visual depictions) action in the widow. In some embodiments, as soon as an action that is not part of a task appears in the subset in a window, the loss will start to increase. Thus, typically, the window size is not 0 or 1 because it needs context or meaning at least size of 2. A sentence may be created action-by-action, one action at a time, with the newest, latest in time action in the subset in the window being added to the sentence, until the loss is above a threshold. Thus, in some embodiments, dividing the series of computer-based actions into segments at points where the loss of NN or autoencoder is above a threshold includes, for each of a sequence of actions within the sliding window, determining if the sequence when provided to the NN corresponds to a loss above (or equal to and above) a threshold. If the sequence when provided to the NN corresponds to or causes the NN to output a loss above a threshold, it is determined that an action in the sequence of actions within the sliding window should not be part of a segment or sentence being created: for example, the last or latest (e.g. most recently added to the sliding window, or latest in time per a timestamp) individual action may be determined to be not part of the sentence, or in the “in-between”, and all actions except for the last action in the sequence of actions within the sliding window should be part of the segment being created.

Actions may be associated with or appended to sentences in various manners. In one embodiment, each sentence created is assigned a sentence number, and a table or association may be created where each action is associated, e.g. using its action ID, with a sentence number. Adding a sentence number to an entry corresponding to an action appends that action to the sentence having the sentence number.

FIG. 4 is a flowchart of a method according to embodiments of the present invention. The operations of FIG. 4 may be performed using systems such as in FIG. 1 and FIG. 5, but other systems may be used.

In operation 500, actions may be collected, e.g. from desk-top monitoring systems executed by computers used by agents. The actions may be pre-processed: e.g. each action may be processed to be represented as a string or another form, generalized and assigned a name or label (e.g. action label 324).

In operation 502, the series of collected and pre-processed actions may be sorted, for example by user and timestamp, to obtain a first series of a number of second series of actions, each second series of actions performed by one person and typically ordered by time.

Typically, after preprocessing, each individual action in the sequence has a genericized name (e.g. four digit name) such as action label 324 and is a specific action with a unique user/timestamp combination, but shares its name with other generalized actions, from the user of the action and other users, having similar characteristics. A unique number or identification may be created for each unique action (e.g. represented by an action description such as a string); each of these actions may be given a number or ID which applies to numerous actions. For example a generalized action description “User InputKey(C) on Main content(edit) _firstName_ _lastName_ ServiceNow—Internet Explorer—iexplore” may be mapped to action ID 1345 as with all other similar actions.

In operation 504 parameters may be set. For example a sliding window size L (e.g. 10) may be set, the total number of unique action IDs V in the stream may be determined, and the number of different generalized actions, each corresponding to one the number of different action IDs, e.g. N, may be determined.

In operation 506, training data may be created based on actions and parameters. In one embodiment, a data matrix may be created based on sliding windows of size L moved in an increment of one action (other increment may be used) across the input stream of N actions. The input to training and inference is typically a stream of action IDs, where each ID may repeat in the stream and each action ID may correspond to numerous specific non-generic instances of actions. The subsets of actions within or defined by each sliding window may be stacked to create a matrix for use as input to train a model. For example, a process may iterate over the actions N-L+1 times to create subsets of size L (defined by sliding windows), each appended to the matrix vertically. Other methods of creating training data may be used.

In operation 508, an untrained model such as an autoencoder, RNN autoencoder, or other NN may be created. In one embodiment, the input layer for the autoencoder is of size L (window size); at least one internal embedding layer is included, of size, for example 100; an RNN layer is used; and an output layer of size L used for categorical cross entropy. Other models and other types of NNs or autoencoders may be used.

In operation 510, the untrained model may be trained, for example using the matrix of training data, or other training data. Data may be formatted or converted prior to training, e.g. each action ID in a data matrix as created in operations 506 may be converted to a categorical type if required by the API (application programming interface) of the autoencoder, as in some embodiments; the autoencoder output may be the categorical. Training may be carried out as known in the art, e.g. using epochs and stopping or early stopping when the change in loss over iterations or epochs drops below a threshold. For example, early stopping may occur when the loss delta is less than 1. Other data formats and training methods may be used.

In operation 512 losses or scores may be produced (e.g. inference) for each of a series of subsets of computer-based actions. Typically, the same sets of subsets used for training is used for inference on the model trained in operation 510. For example, a sliding window may be applied to a sequence of actions, converting the sequence to a sequence of subsets of actions, one subset fitting in each window position, to provide each subset (e.g. each subset of action labels) within a window to a model such as an autoencoder or NN. The sliding window may be applied by having used it to create a matrix, as described herein, the matrix being used as input to a model. Input may be provided to a model in a number of ways, for example by converting the matrix to categorical types before the sliding window is used. A list of loss scores, e.g. one loss score for each window or subset of actions, may be returned.

In operation 514, a loss threshold may be set or calculated. A threshold may be chosen statistically, such as using a percentile, or by choosing a threshold between two elements of a Gaussian function in the case of a bimodal distribution. For example, a loss threshold K may be determined such that X %, e.g. 80%, of the scores determined in operation 512 are below the threshold. A threshold other than based on percentile may be used.

In operation 516, each window or subset of actions defined by a window may be assigned a binary or other rating based on its score. E.g. each window or subset having a loss below the threshold (e.g. K in operation 514) may be assigned 0 (indicating low loss) and each window having a loss greater than or equal to the threshold may be assigned 1 (indicating high loss). In some embodiments this rating may be entered into a mask or array corresponding to window data. Such a pre-processed rating need not be used: e.g. the raw loss may be used when segmenting actions.

In operations 518-528, a process may iterate over the actions. Initially, a counter indicating a sentence number may be set to, e.g., 0, and a counter I indicating a window number or action number may be set to, e.g., 0. The sentence counter may remain the same within sentences, resulting in a sentence being indicated by a repeating series of the sentence's counter, and may be incremented as new sentences are found, and at the end of the process the list of sentence numbers may be assigned to actions. Other ways of assigning sentences to actions may be used. Other parameters may be set, e.g. a “last_mask” parameter indicating the high/low loss assignment of the last mask seen may be set to 0.

Operations 518-528 may segment actions into sentences, omitting or deleting actions that are in between sentences. In other embodiments actions in-between need not be omitted. In one embodiment, actions are segmented based on their containing subset or window; however other methods may be used. In the specific example shown, a sentence, labelled using an integer, is assigned to each action, and after this process is complete actions that are associated with high loss are removed. In some embodiments, if a subset, window or sequence when provided to the NN corresponds to a loss above a threshold (or equal to or above a threshold), it may be determined that an action in the sequence of actions within or defined by the sliding window should not be part of a sentence or segment being created—e.g. may be in-between. Other specific methods may be used: for example, actions may be completely assigned during iteration without post-iteration removal.

In operation 518, it may be determined whether or not there are no more windows or actions over which to iterate. For example, it may be determined if counter I is equal to the total number of actions in the sequence (e.g. N), minus the window size (e.g. L) plus 1, it may be determined that there are no more actions or windows, and the process proceeds to operations 530-532 to finish the process. If there are more actions, the process may continue at operation 520.

In operation 520, if the counter for the window or action being processed, e.g. I, is less than the window size plus 1 (e.g. L+1), it may indicate that I has not progressed past the first window size, and the process may increment I, and proceed to operation 528. If I has progressed past the window size, e.g. I is not less than L+1, the process may proceed to operation 522. Typically, the first L−1 (window size minus 1) actions are assigned a default mask of low loss, since a window for each of these first actions will be incomplete, resulting in a high actual loss.

In operation 522, I may be incremented.

In operation 524, it may be determined if there is transition from high to low or low to high loss, e.g. between actions, subsets or windows with low loss and actions, subsets or windows with high loss. Such a transition may be used to divide the series actions into segments at points where the loss of the NN is above a threshold; such a point may be within or corresponding to a window of actions, the window having high loss. In such a manner a point where the loss is above a threshold—which may be the first new action fed to a model, such as the latest or last action in the latest or last window fed to the model—may be identified. For example, it may be determined if the rating for the last window or subset iterated over is 0 (low loss) and the rating for the current window or subset being iterated over is 1 (high loss), indicating a transition from low to high loss: if yes, in operation 526, the sentence number may be incremented, indicating a new sentence. If no transition, the process may proceed to operation 518.

In other embodiments, other transitions may be detected (e.g. high loss to low loss; or both low to high and high to low). In the example presented only transitions from high to low are detected, and thus a transition to a new sentence (low loss) is not detected, which may require that a later process removes actions corresponding to high loss. The current window or subset being iterated over may be represented by a mask value in a mask. The current window or subset being iterated over may represent the current action being iterated over: e.g. the current window may represent by proxy the last or latest action in that window. In some embodiments, since the actions are sorted by user into blocks of actions from all one user, prior to training, no “cutoff” on the transition between users is used, beyond that the loss for windows including such transitions may be high.

In operation 526, on the detection of a new sentence, the sentence number may be incremented by 1.

In operation 528, the sentence or segment number may be appended to sentence list, resulting for each sentence a repeated series of the same sentence number. In some embodiments, actions are segmented to sentences or segments are segmented by being assigned at the end of the process to a sentence or segment number, using sequential list of actions, e.g. in a table or database. In such a manner the action's entry in the table has added to it a sentence number, where the sentence number changes over time across actions. The process may continue with operation 518.

In operation 530 if there are no more actions over which to iterate, to finish the process, sentence numbers in the sentence number list may be attached to actions in an action list of table, e.g. added to the entry in the table for the action corresponding to that sentence number. E.g., the sequence of sentence numbers may be added, in sequence, to the sequence of actions, assigning each action to a sentence. Other manners of assigning actions to sentences may be used. In one embodiment, the first L−1 actions may have a sentence number initially assigned to zero, as there has been no transition. These first actions, within the first window, may not be possible to accurately assign to a sentence, since their loss is typically always high. Thus the first L−1 actions may be arbitrarily assigned to the first sentence, sentence 1.

In operation 532, actions associated with high loss, e.g. “in-between”, may be removed from the list of actions assigned to sentences, e.g. removed from the table (or have no sentence assigned to it) created in operations 518-528. For example, the last action in each window having mask=1, meaning high loss, may be removed from the sentence in which it appears. If a sequence, subset or window corresponds to a loss above a threshold or equal to or above the threshold, it may be determined that an action in the sequence of actions within the sliding window should not be part of a sentence or segment being created: in one embodiment this is effected by removing the action from a list or table.

In operation 534, use may be made of the sentences produced. For example, sequential pattern mining may be used in order to find useful or high-value sentences or segments. An automation sequence may be created which may include a series of actions executed by a computer system to substitute for actions taken by a user operating a computer system. For example, the automation sequence may include actions input by a bot to software applications: user left clicks on “ordering system”; user inputs username to username field; user inputs password to password field; user clicks “login”. A user may normally perform this sequence of actions, and an automation sequence may have a process on a computer system perform this automation sequence for the user, to automatically and quickly complete the login process for the user. Typically, automation actions such as business process actions are performed on screen elements (e.g. buttons, windows, dropdown menus, text entry fields) in various applications.

Other operations or sequences of operations may be used.

FIG. 5 shows a high-level block diagram of an exemplary computing device which may be used with embodiments of the present invention. Computing device 100 may include a controller or processor 105 that may be, for example, a central processing unit processor (CPU), a chip or any suitable computing device, an operating system 115, a memory 120, a storage 130, input devices 135 and output devices 140 such as a computer display or monitor displaying for example a computer desktop system. Each of modules and equipment such agent terminals 2, software programs 6, computer desktop system 7, RT local interface 8, analytics server 20, server software 22, automation finder module 24, automation module 26 and other modules discussed herein may be or include, or may be executed by, a computing device such as included in FIG. 5, although various units among these modules may be combined into one computing device.

Operating system 115 may be or may include code to perform tasks involving coordination, scheduling, arbitration, or managing operation of computing device 100, for example, scheduling execution of programs. Memory 120 may be or may include, for example, a Random Access Memory (RAM), a read only memory (ROM), a Dynamic RAM (DRAM), a Flash memory, a volatile or non-volatile memory, a cache memory, a buffer, a short or long term memory or other suitable memory units or storage units. Memory 120 may be or may include a plurality of different memory units. Memory 120 may store for example, instructions (e.g. code 125) to carry out a method as disclosed herein, and/or data such as low-level action data, output data, etc.

Executable code 125 may be any application, program, process, task or script. Executable code 125 may be executed by controller 105 possibly under control of operating system 115. For example, executable code 125 may be one or more applications performing methods as disclosed herein, for example those of FIG. 4, according to embodiments of the present invention. In some embodiments, more than one computing device 100 or components of device 100 may be used for some functions. One or more processor(s) 105 may be configured to carry out embodiments of the present invention by for example executing software or code. Storage 130 may be or may include, for example, a hard disk drive, a floppy disk drive, a Compact Disk (CD) drive, a CD-Recordable (CD-R) drive, a universal serial bus (USB) device or other suitable removable and/or fixed storage unit. Data described herein may be stored in a storage 130 and may be loaded from storage 130 into a memory 120 where it may be processed by controller 105. Some of the components shown in FIG. 5 may be omitted.

Input devices 135 may be or may include a mouse, a keyboard, a touch screen or pad or any suitable input device or combination of devices. Output devices 140 may include one or more displays, speakers and/or any other suitable output devices or combination of output devices. Any applicable input/output (I/O) devices may be connected to computing device 100, for example, a wired or wireless network interface card (NIC), a modem, printer, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

Embodiments of the invention may improve the technologies of computer automation, computer bots, big data analysis, NN user, and computer use and automation analysis by using specific algorithms to analyze large pools of data, a task which is impossible, in a practical sense, for a person to carry out.

One skilled in the art will realize the invention may be embodied in other specific forms without departing from the spirit or essential characteristics thereof. The embodiments described herein are therefore to be considered in all respects illustrative rather than limiting. Scope of the invention is thus indicated by the appended claims, rather than by the detailed description, and all changes that come within the meaning and range of equivalency of the claims are therefore intended to be embraced therein. In detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. The scope of the invention is limited only by the claims which are intended to cover all such modifications and changes as fall within the true spirit of the invention.

Embodiments comprising different combinations of features noted in the described embodiments, will occur to a person having ordinary skill in the art. Features or elements described with respect to one embodiment or flowchart can be combined with or used with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

What is claimed is:

1. A method for segmenting a series of computer-based actions, comprising:
using a computer processor, providing a sequence of subsets of the series of computer-based actions to a neural network using a sliding window; and
dividing the series of computer-based actions into segments at points where the loss of the neural network is above a threshold.

2. The method of claim 1, wherein dividing the series of computer-based actions into segments at points where the loss of the neural network is above a threshold comprises:
for each of a sequence of computer-based actions within a sliding window determining if the sequence when provided to the neural network corresponds to a loss above or equal to a threshold; and
if the sequence when provided to the neural network corresponds to a loss above or equal to a threshold, determining that an action in the sequence of actions within the sliding window should not be part of a segment being created.

3. The method of claim 2, wherein determining that an action defined by the sliding window should not be part of a segment being created comprises removing the last action in the sequence of actions within a sliding window from a list.

4. The method of claim 1 where the neural network is an autoencoder.

5. The method of claim 1 where the threshold is set as a percentile of losses.

6. The method of claim 1, wherein the neural network is trained using the sequence of subsets.

7. The method of claim 1, comprising providing to a user a next suggested action.

8. A system for segmenting a series of computer-based actions, comprising:
a memory; and
a processor configured to:
provide a sequence of subsets of the series of computer-based actions to a neural network using a sliding window; and
divide the series of computer-based actions into segments at points where the loss of the neural network is above a threshold.

9. The system of claim 8, wherein dividing the series of computer-based actions into segments at points where the loss of the neural network is above a threshold comprises:
for each of a sequence of computer-based actions within a sliding window determining if the sequence when provided to the neural network corresponds to a loss above or equal to a threshold; and
if the sequence when provided to the neural network corresponds to a loss above or equal to a threshold, determining that an action in the sequence of actions within the sliding window should not be part of a segment being created.

10. The system of claim 9, wherein determining that an action defined by the sliding window should not be part of a segment being created comprises removing the last action in the sequence of actions within a sliding window from a list.

11. The system of claim 8 where the neural network is an autoencoder.

12. The system of claim 8 where the threshold is set as a percentile of losses.

13. The system of claim 8, wherein the neural network is trained using the sequence of subsets.

14. The system of claim 8, wherein the processor is configured to provide to a user a next suggested action.

15. A method for forming a series of computer-based actions into sentences, the method comprising:
using a computer processor, providing series of windows each comprising computer-based actions to a neural network; and
forming sentences of computer-based actions based on the loss of the windows when input to a neural network.

16. The method of claim 15, wherein forming sentences comprises:
for each window determining if the window when provided to the neural network corresponds to a loss above or equal to a threshold; and
if loss is above or equal to a threshold, determining that an action in the window should not be part of a sentence being created.

17. The method of claim 16, wherein determining that an action in the window should not be part of a sentence comprises removing the last action in a sequence of actions within the window from a list.

18. The method of claim 15 where the neural network is an autoencoder.

19. The method of claim 15 where the threshold is based on a percentile of losses.

20. The method of claim 15, wherein the neural network is trained using the sequence of subsets.
